(19) United States
(12) Patent Application Publication
(10) Pub. No.: US 2026/0252617 A1
(43) Pub. Date: Aug. 27, 2026

(54) Customized Chunking Recommendations for Document Corpus

(71) Applicant: Unstructured Technologies, Inc., Wilmington, DE (US)

(72) Inventors: Maksymilian Operlejn, Gdansk (PL); Jia Shen, Lemont, PA (US); Renyu Li, San Diego, CA (US); Crag Wolfe, San Jose, CA (US); Ryan Nikolaidis, Portland, OR (US)

(21) Appl. No.: 19/065,483

(22) Filed: Feb. 27, 2025

(51) Int. Cl. G06F 16/35; G06F 16/93

(52) U.S. Cl. CPC G06F 16/35; G06F 16/93

(57) ABSTRACT

In one embodiment, a method includes splitting a set of documents into a group of document sections; generating, from the group of document sections, a set of questions and corresponding answers, where each answer comes from content within the group of document sections; and extracting, by each of multiple chunking techniques, a group of document chunks from the document sections. The method further includes, for each chunking technique, determining one or more performance scores based on whether the respective group of chunks' similarity to the set of questions corresponds to the respective answers; and selecting, based on the determined one or more performance scores, at least one chunking technique to use to chunk a corpus of documents that includes the set of documents.

### TECHNICAL FIELD

This application generally relates to generating customized recommendations for chunking a corpus of electronic documents.

### BACKGROUND

Information stored electronically is often used for retrieval and content generation. For example, a bank employee may want to look up information regarding bank guidelines for storing sensitive customer information, or an attorney preparing a merger agreement may want to start with a previous agreement to use as a template, rather than drafting the agreement from scratch. Information is often stored electronically in many different forms and in many different file formats, and information stored in an electronic file is generally referred to as a “document,” regardless of the format and form that the electronic file takes. Many entities store thousands of documents or millions of documents, and some store even more.

Accurate information retrieval and content generation can require information from one portion of a document, from multiple portions of a document, or even from multiple documents. Techniques that recognize text on a page, such as optical character recognition, may be used for storing text in searchable format, for example so that keyword searches may be run on documents, but such techniques rely on elementary language matching (e.g., searching for exact words or phrases, or for particular words that are within a particular distance from other words) and do not take into account semantic meaning of a document's contents. In addition, such techniques do not generate content (e.g., answers) from information contained in electronic documents.

### BRIEF DESCRIPTION OF THE DRAWINGS

FIG. 1 illustrates an example method for recommending a chunking technique for chunking a document corpus for downstream AI-assisted tasks.

FIG. 2 illustrates an example computing system.

### DESCRIPTION OF EXAMPLE EMBODIMENTS

Artificial intelligence (AI) technology can provide many types of assistance for users exploring a corpus of electronic documents. For example, large language models (LLMs) can receive natural-language queries (e.g., spoken or written queries) and can provide natural-language output based on the contents of documents in the corpus. For instance, LLMs can answer queries on the contents of documents, or generate a template for a particular kind of document from documents in a corpus. As another example, machine-learning models can be used to find many different kinds of patterns within a corpus of documents. AI assistance is revolutionary both in terms of the services it can provide (e.g., natural-language understanding and generation) and in its ability to provide information services on what can be a huge corpus of documents (e.g., a set of millions of documents).

However, creating a system that provides AI-assistance on a particular corpus of documents is a complex and difficult task. For example, for an LLM to answer queries on a user's corpus of documents, the LLM needs to semantically understand the contents of the documents in a way that corresponds to the information requested in the query. This is difficult for multiple reasons. For instance, documents take many different formats (e.g., spreadsheets, text-based documents, web-based documents, email documents, images, etc.), and different formats may define a document's contents very differently. Documents in a corpus therefore typically need to be normalized in a consistent way before an LLM can semantically understand the document's contents. In addition, a document's semantic meaning depends on what portion of the document is being considered, what content is in that portion, and how big that portion is.

For example, a 1,000+ page cookbook may generally describe techniques for preparing food. But that overview characterization of the entire cookbook is not useful for answering the specific question of “how does one make the top of a crème brûlée crunchy?” or “how long should I blanch broccoli for an antipasto salad?” Likewise, a document may contain different types of content, such as images, tables, and text, each of which provides information in different ways. For example, suppose a page of a cookbook textually and graphically describes a procedure for rolling bread dough. Asking “what information does this page show?” is a complex question that does not have a single answer, and both the text and images would need to be considered when providing an answer. In addition, both the portion of the page being considered and the relevancy of the information should be considered. For instance, “use a roller that has a light brown color” is unlikely to be relevant information for rolling bread dough, even if an image illustrates a light brown roller. Likewise, the portion or page being considered affects what information is being communicated. For example, a particular image and corresponding sentence that describes the need to sprinkle flour on the surface used to roll the dough provides more specific, but also more limited, information than would three full pages devoted to techniques for rolling bread dough. In addition, AI models (including LLMs) have limited memory that limits the context length used by the model. For example, inputting to an LLM the entire contents of a 1000+ page cookbook as “context” for a particular query is not a feasible approach because a context of this size would exceeds the memory limits of the LLM.

Creating a robust system for AI-assisted tasks on a document corpus typically requires accessing the document corpus, splitting each document into portions (also referred to document chunks), and then computationally representing the semantic meaning within each document chunk. For instance, semantic meaning may be represented by embedding chunks, using any of a number of embedding approaches to represent the content in the chunk as a vector in an embedding space. These embeddings can then be stored in a database and accessed by an AI model during runtime for an AI-assisted task (e.g., to answer a user query on the document corpus).

However, actually implementing this process requires choosing among many different approaches and parameters values, each of which affects downstream performance on the AI-assisted tasks. As just one example, the choice of how and where to divide a document into chunks affects how those chunks are semantically understood by an embedding model. As another example, the choice of embedding model itself affects downstream task performance. Complicating this endeavor is the fact that accurate performance, and thus the corresponding approach to implement, varies based on the user's specific document corpus, and even on the specific task the user wishes to perform (e.g., information retrieval vs. content generation). And finally, creating a database from a document corpus that results in accurate run-time performance takes significant resources, including compute and financial resources, and therefore using trial-and-error to test many different approaches for creating an AI-usable database from the document corpus is prohibitively expensive in terms of money, compute resources, and time.

This disclosure focuses on techniques for chunking a user's document corpus. Typically, document chunks are then embedded in a database so that an AI model (e.g., an LLM) can later access the database and perform AI-assisted tasks. For example, an LLM may receive a user query in natural-language form, embed the query using the same embedding technique as was used to embed the document chunks, and then intelligently return a query answer based on the query and corpus embeddings. Chunking has a significant effect on downstream task performance, as chunking defines the specific documents portions that will be embedded, and therefore defines how content throughout the corpus is partitioned. As explained above, the choice of how to chunk a document fundamentally defines how a document is semantically defined. For example, the answer to “what is this section about” when asked about a chapter that describes surgical techniques is very different than when asked about a few sentences in the same chapter that specifically describes various aqueous solutions for sanitizing a scalpel. The techniques described herein determine a recommended chunking approach on the user's specific corpus of documents, focusing on the downstream AI-task performance on that corpus.

As explained herein, many different chunking approaches exist, and these different approaches have varying performance levels for different document corpuses. It is almost always infeasible for a user to simply test each chunking approach on their document corpus, and in addition, once chunking is performed, it is costly to re-do chunking with a different chunking approach due to poor downstream tasks performance.

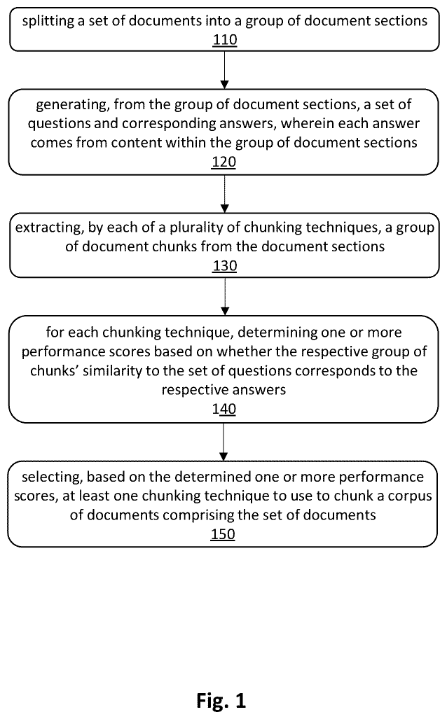

In contrast, the techniques described herein can test, accurately analyze chunking efficacy, and accurately and efficiently recommend a particular chunking approach that performs best for a particular corpus of documents. FIG. 1 illustrates an example method for recommending a chunking technique for chunking a document corpus for downstream AI-assisted tasks. Step 110 of the example method of FIG. 1 includes splitting a set of documents into a group of document sections. In particular embodiments, the set of documents may be a representative set of documents of a larger (often much larger) corpus of documents. For example, an end user may have thousands, hundreds of thousands, or millions (or more) of documents in a corpus. The corpus of documents may include many different files types.

As discussed above, chunking can be a resource-intensive process in terms of time, monetary resources, and compute resources. Evaluating many different chunking techniques (or even more than one technique, for large document corpuses) on a corpus of documents is therefore often infeasible. The corpus of documents may therefore be split into a smaller, but representative set of documents. Representative documents may be determined based on the file structure of the documents, the contents of the documents, or both. For example, if a corpus includes many financial 10-K reports for a company, then only one or a few 10-Ks are sufficient to represent the larger set of 10-K documents, because such documents typically have a fixed format and meaning, even though the actual values set forth in the 10-K vary from 10-K to 10-K. In particular embodiments, an AI model such as an LLM may be used to summarize each document, which then defines that document's content and file structure. In particular embodiments, a clustering algorithm, such as a k-means clustering algorithm, may be used to create clusters of documents based on document similarity, and then the clusters may be sampled (e.g., by a random sample, which may be constrained to be statistically representative of the distribution of clustered documents).

In particular embodiments, the document sections may be a representative sample of sections of documents from the representative set of documents. In other words, a representative set of documents may be selected from a larger corpus of documents, and then a representative set of document sections may be selected from the set of representative documents. A document section may be a page, a half page, a chapter, or other division.

In particular embodiments, a representative sample of document sections may be selected from a representative sample of documents based on clustering the contents of the respective sections (e.g., based on the contents of the respective pages). For example, pages from a set of documents may be clustered based on the content as defined by documents elements, which include classification labels that identify document portions according to a consistent element definition. For example, a document may be parsed into its elements, for example by identifying documents portions according to the predetermined element definitions and then labelling those portions with an element classification label. For example, elements in a document may be classified by a trained classifier. A set of ground-truth elements may be manually labeled according to the predetermined element definition, and the set of labels is also predetermined. For example, a set of labels can include “text,” “handwriting,” “image,” “table,” “title,” “header,” “page number,” and so on, although other labels may also be used. The ground-truth examples and corresponding labels are used to train the classifier until a stopping condition is reached . The training results may be evaluated, for example using a confusion matrix, which may identify how well the predetermined set of classification labels works for labelling elements. For instance, the confusion matrix may identify that certain class labels should be merged, or that a class label should be split into multiple labels.

Once trained, the classifier receives as input some or all of an accessed document. For example, a classifier may receive a document on a page-by-page basis, although other divisions may be used. For each element identified in the classifier's input, the classifier assigns an element label. Thus, the accessed document is converted to a set of elements, each classified with a document-element label.

In particular embodiment, document sections (e.g., pages) from a set of documents may be clustered based on the content as defined by documents elements. For instance, a document section may be represented by a vector, with each vector dimension corresponding to an element type, and the vector values may represent how much of the document section represents the respective element type. The document sections may then be clustered, based on the vectorized document sections, and the clusters may be sampled (e.g., randomly sampled, sampled so that the sample statistically represents the cluster distribution, etc.) to obtain a representative set of document sections. In particular embodiments, portioning documents into a set of well-defined elements, generating a representative sample of documents in a corpus, and then generating a representative sample of sections (e.g., pages) of the documents in the representative sample based on the elements of those sections, greatly reduces the amount of data that is processed during the chunking techniques described herein, while still resulting in chunking metrics that reflect the performance of various chunking strategies on the overall document corpus.

In particular embodiments, a representative sample of document sections may be obtained based on an initial chunking approach. For example, document sections may initially be chunked by title (e.g., a chunk is defined starting with a “title” element and includes content up to a character limit or until another element (e.g., another title element) is reached), and the resulting chunks may be clustered and sampled to identifying representative document sections. However, once the representative document sections are obtained, then many different chunking techniques may be evaluated on those sections, i.e., chunk-by-title is not the only chunking technique used, as described below.

In particular embodiments, a representative set of documents may include sampling a fixed number of sections per cluster (e.g., 3-5 sections per cluster), or may include generating a sample that statistically matches the cluster distribution (e.g., a cluster that contains 100 document sections would be sampled more heavily than a cluster that contains 20 document sections).

Step 120 of the method of FIG. 1 includes generating, from the group of document sections, a set of questions and corresponding answers. Each answer comes from content within the group of document sections, often verbatim. Any of many different techniques for generating questions from content in a section (e.g., a page) may be used. For example, some techniques generate a question from a particular section of text (e.g., from a sentence or a paragraph), while other techniques generate a question from two or more document portions (e.g., answering the question requires referencing two distinct paragraphs, two distinct pages, etc.). Other techniques may generate questions from elements that are not exclusively text, such as from images or tables.

In particular embodiment, step 120 includes generating questions and corresponding answers using many different question-generation techniques, so that chunking techniques are evaluated with respect to many different downstream tasks (e.g., with respect to asking a question that is answered by a particular document portion, with respect to asking a question that is answered only by tying together multiple portions of a document, with respect to asking a question that requires referencing an image or a table to answer, etc.), as different chunking techniques may have different performance relative to these different kinds of downstream tasks.

In particular embodiments, step 120 may include generating a fixed number of questions per document section (e.g., one question per document page), although other approaches may be used. In particular embodiments, step 120 may include filtering the generated set of questions and answers, e.g., filtering out questions that do not correspond well to the designated answers. In particular embodiments a question may be a statement or other text fragment that corresponds to the ground-truth answer (e.g., the question need not be a literal question, e.g., a sentence that ends with a question mark).

Step 130 of the example method of FIG. 1 includes extracting, by each of a plurality of chunking techniques, a group of document chunks from the document sections. In particular embodiments, step 130 may be performed in parallel with step 120, as each step works on the set of document sections. Step 130 may use any suitable chunking techniques, including techniques that chunk based on a sliding character window (e.g., one chunk consists of, e.g., 100 characters, the next chunk consists of 100 characters sliding 10 characters forward in reading order); on an element-based chunking (e.g., chunking by title); on a similarity-based chunking; on a section-based chunking (e.g., each page or half a page is chunk), among other approaches.

In particular embodiments, different chunking techniques may also include different parameter values for a particular type of chunking technique. For example, the maximum character length for a chunk is a parameter that affects chunk size, which affects embedding results, even for the same general chunking approach (e.g., chunk by title). Therefore, different chunking techniques may include varying values for the parameters used by one particular general chunking approach, to determine which approach-and-parameter combination is best suited to the user's particular document corpus.

Step 140 of the example method of FIG. 1 includes for each chunking technique, determining one or more performance scores based on whether the respective group of chunks' similarity to the set of questions corresponds to the respective answers. For instance, the chunks for each chunking technique may be embedded by one or more embedding models, and the questions generated in step 120 may likewise be embedded by the one or more embedding models. The performance score for a chunking technique may be evaluated based on any of several metrics for determining task performance on the embeddings.

For example, one performance score may involve retrieving, for each embedded question, the most similar (e.g., based on a distance metric) n embedded chunks (e.g., 4 chunks, 10 chunks, etc.). If the ground-truth answer generated in step 120 to the question can be determined from the most similar n embedded chunks, then the particular chunking technique may receive a relatively high performance score. In particular embodiments, a performance score may also evaluate whether the chunk(s) that contain the ground-truth answer (assuming the nearest n chunks in fact include the answer) contain additional content (e.g., additional text), and if so, how much additional, unnecessary content is present in those chunks that determine the answer. In other words, the presence of chunks that answer a query but also contain relatively more irrelevant content may result in a relatively lower score.

In particular embodiments, a performance score may be based on a precision metric, e.g., out of all the n retrieved chunks for a particular chunking technique, how many are relevant to answering the question? In particular embodiments, performance scores (such as precision) may be evaluated by considering the most similar chunk to the question, then evaluated again by considering the most similar two chunks to the question, then evaluated again by considering the most similar three chunks to the question, and so on until the n chunks are considered.

In particular embodiments, a performance score may include a recall score, which determines whether the ground-truth answer is found in any of the n most similar chunks, for a particular chunking technique. In particular embodiment, a performance score may be based on the relative position in the n chunks in which a ground truth answer is found. For example, if a ground-truth answer is found in the most similar two chunks, then that result would receive a relatively higher score than if the ground-truth answer was found in the sixth and seventh most similar chunks. As another example, a relatively higher performance score may be obtained if the ground-truth answer is found anear either end of the n chunks (e.g., in the most similar n chunks or in the least similar of the n most similar chunks), as particular AI models (e.g., some LLMs) used in downstream task performance perform worse when relevant content is found in the middle of a set of returned results, rather than at the ends of the set. In particular embodiments, performance scores may be aggregated for each chunking technique, e.g., using mean average precision and/or analyzing the frequency and distribution of n-grams in returned chunks to understand how well a chunking technique is capturing patterns and relationships within a document.

Step 150 of the example method of FIG. 1 includes selecting, based on the determined one or more performance scores, at least one chunking technique to use to chunk a corpus of documents that includes the set of documents. In particular embodiments, a trained AI model (e.g., a trained LLM) may be asked to determine which chunking technique performs best, based on the performance scores, on step 140 for the document set taken from the particular document corpus at issue. In particular embodiments, step 150 may include selecting a single chunking technique, while in other embodiments, step 150 may include selecting the top x techniques, which may be surfaced to a user of the document corpus. For instance, the top x techniques may be surfaced along with, in particular embodiments, a description of why that technique was selected as a top-performing technique (e.g., the particular tasks that the chunking technique led to relatively strong performance or relatively weak performance), so that the end user can select the best top-performing chunking technique that also corresponds to the particular AI-assisted tasks that the user will employ. In particular embodiment, chunking techniques may be selected for particular kinds of documents in the user's corpus, based on the performance scores (e.g., one type of chunking technique may be used for long documents while another may be used for shorter documents, or one chunking technique may be used for documents that contain several images while another is used for documents that contain mostly text, etc.).

Once the chunking technique is selected, then that chunking technique is used to chunk all the documents in the user's corpus. These chunks are typically then embedded (with, in particular embodiments, other processing such as enrichment or normalization) and placed into the end user's database so that the end user's AI model(s) (e.g., LLMs) can perform AI-assisted tasks on the document corpus. As explained above, the result is a chunking technique (or chunking techniques) that are efficiently and accurately tailored to the user's particular document corpus and intended downstream AI-assisted tasks.

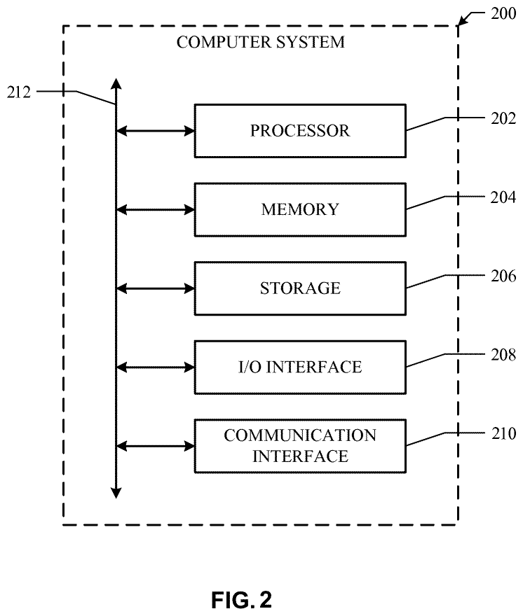

FIG. 2 illustrates an example computer system 200. In particular embodiments, one or more computer systems 200 perform one or more steps of one or more methods described or illustrated herein. In particular embodiments, one or more computer systems 200 provide functionality described or illustrated herein. In particular embodiments, software running on one or more computer systems 200 performs one or more steps of one or more methods described or illustrated herein or provides functionality described or illustrated herein. Particular embodiments include one or more portions of one or more computer systems 200. Herein, reference to a computer system may encompass a computing device, and vice versa, where appropriate. Moreover, reference to a computer system may encompass one or more computer systems, where appropriate.

This disclosure contemplates any suitable number of computer systems 200. This disclosure contemplates computer system 200 taking any suitable physical form. As example and not by way of limitation, computer system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 200 may include one or more computer systems 200; be unitary or distributed; span multiple locations; span multiple machines; span multiple data centers; or reside in a cloud, which may include one or more cloud components in one or more networks. Where appropriate, one or more computer systems 200 may perform without substantial spatial or temporal limitation one or more steps of one or more methods described or illustrated herein. As an example and not by way of limitation, one or more computer systems 200 may perform in real time or in batch mode one or more steps of one or more methods described or illustrated herein. One or more computer systems 200 may perform at different times or at different locations one or more steps of one or more methods described or illustrated herein, where appropriate.

In particular embodiments, computer system 200 includes a processor 202, memory 204, storage 206, an input/output (I/O) interface 208, a communication interface 210, and a bus 212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In particular embodiments, memory 204 includes main memory for storing instructions for processor 202 to execute or data for processor 202 to operate on. As an example and not by way of limitation, computer system 200 may load instructions from storage 206 or another source (such as, for example, another computer system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses, as described below. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory.

In particular embodiments, storage 206 includes mass storage for data or instructions. As an example and not by way of limitation, storage 206 may include a hard disk drive (HDD), a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to computer system 200, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In particular embodiments, I/O interface 208 includes hardware, software, or both, providing one or more interfaces for communication between computer system 200 and one or more I/O devices. Computer system 200 may include one or more of these I/O devices, where appropriate. One or more of these I/O devices may enable communication between a person and computer system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

In particular embodiments, communication interface 210 includes hardware, software, or both providing one or more interfaces for communication (such as, for example, packet-based communication) between computer system 200 and one or more other computer systems 200 or one or more networks. As an example and not by way of limitation, communication interface 210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 210 for it. As an example and not by way of limitation, computer system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 200 may include any suitable communication interface 210 for any of these networks, where appropriate. Communication interface 210 may include one or more communication interfaces 210, where appropriate. Although this disclosure describes and illustrates a particular communication interface, this disclosure contemplates any suitable communication interface.

In particular embodiments, bus 212 includes hardware, software, or both coupling components of computer system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure contemplates a system that includes one or more non-transitory computer readable storage media storing instructions; and one or more processors coupled to the one or more non-transitory computer readable storage media and operable to execute the instructions to perform certain functions includes embodiments in which those functions are performed by a single processor, embodiments in which those functions are performed by multiple processors that each perform all the functions, and embodiments in which those functions are performed by multiple processors (e.g., in separate computing devices) where each processor performs at least one function but less than all recited functions.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend.

1. A method comprising:
accessing a corpus of documents;
generating, from the corpus of documents, a set of documents that is (1) representative of the corpus of documents and that is (2) smaller than the corpus of documents, based on one or more of (1) a file structure of the documents in the corpus or (2) a content of the documents in the corpus;
splitting the set of documents representative of the corpus of documents into a set of document sections;
generating, from the set of document sections, a group of document sections comprising a representative sample of the set of document sections that is smaller than the set of document sections, such that (1) the group of document sections is representative of the set of document sections and (2) the set of document sections are generated from a set of documents that are representative of the corpus of documents;
generating, from the group of document sections, a set of questions and corresponding answers, wherein each answer comes from content within the group of document sections;
extracting, by each of a plurality of chunking techniques, a group of document chunks from the representative group of document sections;
for each chunking technique, determining one or more performance scores based on whether the respective group of chunks' similarity to the set of questions corresponds to the respective answers;
selecting, based on the determined one or more performance scores, at least one chunking technique to use to chunk the corpus of documents;
chunking the corpus of documents using the selected at least one chunking technique; and
embedding the chunked corpus and storing the embeddings in a database accessible by an AI model during execution of an AI-assisted task on the corpus of documents.

2-3. (canceled)

4. The method of claim 1, further comprising generating the representative sample of document sections by:
dividing the set of documents into a set of document elements, each document element having a classification label defining that element;
for each document section, creating a vector representing the elements within that document section;
clustering the vectors representing the elements within the document sections; and
selecting, based on the clustered vectors, the representative sample of document sections.

5. The method of claim 1, wherein each of at least some of the plurality of chunking techniques comprise a chunking technique having a unique set of parameters values associated with the chunking technique.

6. The method of claim 1, wherein the performance scores comprise one or more of a precision or a recall.

7. The method of claim 1, wherein the group of chunks' similarity to the set of questions comprises a distance, in an embedding space, between each of at least some of the group of chunks and each question.

8. One or more non-transitory computer readable storage media storing instructions that are operable when executed to:
access a corpus of documents;
generate, from the corpus of documents, a set of documents that is (1) representative of the corpus of documents and that is (2) smaller than the corpus of documents, based on one or more of (1) a file structure of the documents in the corpus or (2) a content of the documents in the corpus;
split the set of documents representative of the corpus of documents into a set of document sections;
generate, from the set of document sections, a group of document sections comprising a representative sample of the set of document sections that is smaller than the set of document sections, such that (1) the group of document sections is representative of the set of document sections and (2) the set of document sections are generated from a set of documents that are representative of the corpus of documents;
generate, from the group of document sections, a set of questions and corresponding answers, wherein each answer comes from content within the group of document sections;
extract, by each of a plurality of chunking techniques, a group of document chunks from the representative group of document sections;
for each chunking technique, determine one or more performance scores based on whether the respective group of chunks' similarity to the set of questions corresponds to the respective answers;
select, based on the determined one or more performance scores, at least one chunking technique to use to chunk the corpus of documents;
chunk the corpus of documents using the selected at least one chunking technique; and
embed the chunked corpus and storing the embeddings in a database accessible by an AI model during execution of an AI-assisted task on the corpus of documents.

9-10. (canceled)

11. The media of claim 8, wherein the instructions are further operable when executed to generate the representative sample of document sections by:
dividing the set of documents into a set of document elements, each document element having a classification label defining that element;
for each document section, creating a vector representing the elements within that document section;
clustering the vectors representing the elements within the document sections; and
selecting, from the clustered vectors, the representative sample of document sections.

12. The media of claim 8, wherein each of at least some of the plurality of chunking techniques comprise a chunking technique having a unique set of parameters values associated with the chunking technique.

13. The media of claim 8, wherein the performance scores comprise one or more of a precision or a recall.

14. A system comprising one or more non-transitory computer readable storage media storing instructions; and one or more processors coupled to the one or more non-transitory computer readable storage media and operable to execute the instructions to:
access a corpus of documents;
generate, from the corpus of documents, a set of documents representative of the corpus of documents, based on one or more of (1) a file structure of the documents in the corpus or (2) a content of the documents in the corpus;
split the set of documents representative of the corpus of documents into a set of document sections;
generate, from the set of document sections, a group of document sections comprising a representative sample of the set of document sections, such that (1) the group of document sections is representative of the set of document sections and (2) the set of document sections are generated from a set of documents that are representative of the corpus of documents;
generate, from the group of document sections, a set of questions and corresponding answers, wherein each answer comes from content within the group of document sections;
extract, by each of a plurality of chunking techniques, a group of document chunks from the representative group of document sections;
for each chunking technique, determine one or more performance scores based on whether the respective group of chunks' similarity to the set of questions corresponds to the respective answers;
select, based on the determined one or more performance scores, at least one chunking technique to use to chunk the corpus of documents;
chunk the corpus of documents using the selected at least one chunking technique; and
embed the chunked corpus and storing the embeddings in a database accessible by an AI model during execution of an AI-assisted task on the corpus of documents.

15-16. (canceled)

17. The system of claim 14, further comprising one or more processors coupled to the one or more computer readable storage media and operable to execute the instructions to generate the representative sample of document sections by:
dividing the set of documents into a set of document elements, each document element having a classification label defining that element;
for each document section, creating a vector representing the elements within that document section;
clustering the vectors representing the elements within the document sections; and
selecting, based on the clustered vectors, the representative sample of document sections.

18. The system of claim 14, wherein each of at least some of the plurality of chunking techniques comprise a chunking technique having a unique set of parameters values associated with the chunking technique.

19. The system of claim 14, wherein the performance scores comprise one or more of a precision or a recall.

20. The system of claim 14, wherein the group of chunks' similarity to the set of questions comprises a distance, in an embedding space, between each of at least some of the group of chunks and each question.

21. The method of claim 1, wherein generating the sets of questions and corresponding answers comprises generating at least one question from two separate document sections.

22. The method of claim 1, wherein selecting at least one chunking technique comprises selecting a plurality of chunking techniques, each chunking technique associated with a particular kind of document within the corpus of documents.

23. The media of claim 8, wherein generating the sets of questions and corresponding answers comprises generating at least one question from two separate document sections.

24. The media of claim 8, wherein selecting at least one chunking technique comprises selecting a plurality of chunking techniques, each chunking technique associated with a particular kind of document within the corpus of documents.

25. The system of claim 14, wherein generating the sets of questions and corresponding answers comprises generating at least one question from two separate document sections.

26. The system of claim 14, wherein selecting at least one chunking technique comprises selecting a plurality of chunking techniques, each chunking technique associated with a particular kind of document within the corpus of documents.
